(19) United States
(12) Patent Application Publication
(10) Pub. No.: US 2025/0042301 A1
(43) Pub. Date: Feb. 6, 2025

(54) Cooling batteries of electric vehicles

(71) Applicant: STOREDOT LTD., Herzeliya (IL)

(72) Inventor: Dan Corfas, Kfar Saba (IL)

(73) Assignee: STOREDOT LTD., Herzeliya (IL)

(21) Appl. No.: 18/364,473

(22) Filed: Aug. 2, 2023

(51) Int. Cl. B60L 58/26; B60K 11/04; H01M 10/613; H01M 10/625; H01M 10/63; H01M 10/6568; H02J 3/38

(52) U.S. Cl. CPC B60L 58/26; B60K 11/04; H01M 10/613; H01M 10/625; H01M 10/63; H01M 10/6568; H02J 3/38; B60L 2240/545; H01M 2220/20; H02J 2300/24

(57) ABSTRACT

A method for cooling a battery unit of an electric vehicle, the method includes fluidly coupling a daytime passive radiative cooling (DPRC) based cooling unit to a battery unit cooling element that is in fluid communication with the battery unit; and cooling the battery unit cooling element by the DPRC based cooling unit.

### BACKGROUND

Storage of a battery at high temperature has an adverse effect on the longevity and service life of the battery.

Electric vehicles may be idle during lengthy periods. For example—passenger electric vehicles are idle most of the time.

When placed outside—the one or more batteries of the electric vehicle can heat up to and even above ambient temperatures with direct sunlight and thus reduce their lifespan.

When not-idle, the electric vehicle cools the one or more batteries using high power consuming solutions (mostly using a compression cycle heat-pump) for cooling the one or more batteries. These high power consuming solutions cannot be used during long idle period—as they will drain the one or more batteries.

There is a growing need to provide a solution for cooling the one or more batteries of an electric vehicle when the electric vehicle is idle.

### SUMMARY

There may be provide a system, a non-transitory computer readable medium and a method for cooling batteries of electric vehicles.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates an example of an electric vehicle;

FIG. 2 illustrates an example of an electric vehicle;

FIG. 3 illustrates an example of an electric vehicle;

FIG. 4 illustrates an example of an electric vehicle;

FIG. 5 illustrates an example of an electric vehicle;

FIG. 6 illustrates an example of an electric vehicle;

FIG. 7 illustrates an example of an electric vehicle;

FIG. 8 illustrates an example of an electric vehicle;

FIG. 9 illustrates an example of a daytime passive radiative cool unit; and

FIG. 10 illustrates an example of a method.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and/or should be applied mutatis mutandis to a non-transitory computer readable medium that stores instructions for executing the method.

Any reference in the specification to a system should be applied mutatis mutandis to a method for utilizing the system and/or should be applied mutatis mutandis to a non-transitory computer readable medium that stores instructions executable by the system.

Any reference in the specification to a non-transitory computer readable medium should be applied mutatis mutandis to a method for executing the instructions and/or should be applied mutatis mutandis to a system configured to execute the instructions.

Any combination of any module or unit listed in any of the figures, any part of the specification and/or any claims may be provided.

Any combination of any steps of any method illustrated in the specification and/or drawings may be provided.

Any combination of any subject matter of any of claims may be provided.

According to an embodiment, there is provided, in addition to an high-power consuming cooling unit (that is effective when the EV is active), a daytime passive radiative cool (DPRC) based cooling unit that may operate when the EV is idle. The DPRC based cooling scheme may provide a very low power and long term cooling solution.

The high-power consuming cooling unit 40 is expected to consume more power during cooling (for example by a factor of at least 1.5, 2, 3, 4, 5, 6, 10, 15, 20, 30 and more) than the DPRC based cooling unit 50.

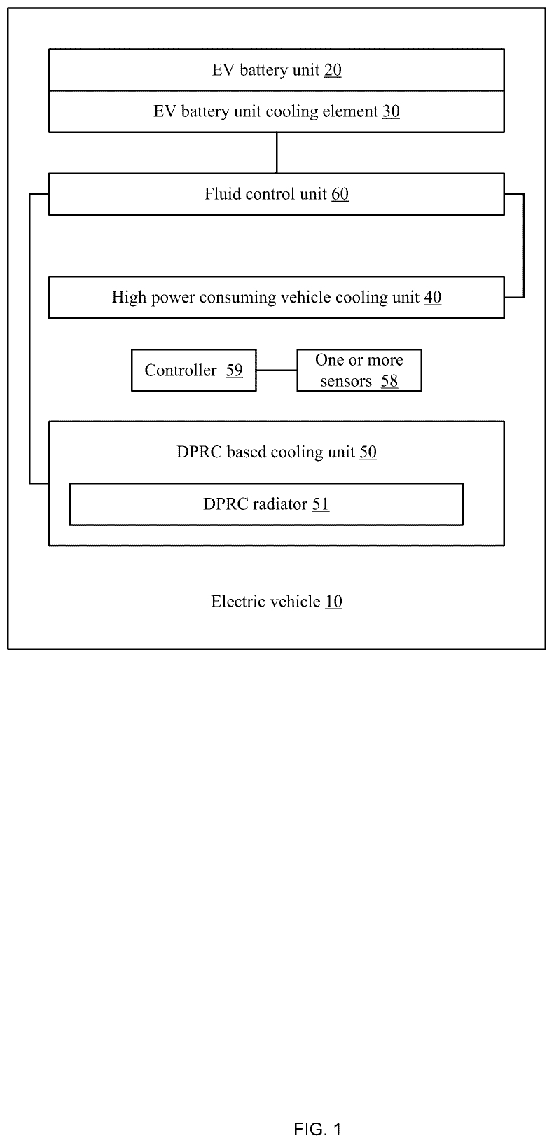

FIG. 1 illustrates an example of EV 10.

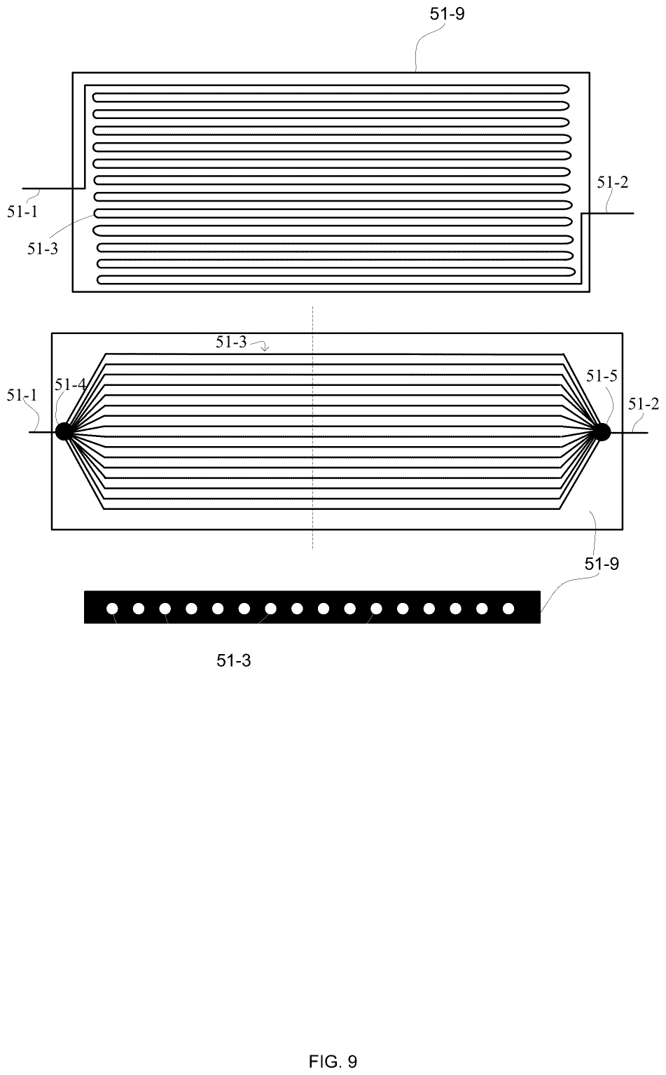

EV 10 includes:
a. EV battery unit 20.
b. EV battery unit cooling element 30 that is thermally coupled to the EV battery unit 20. The EV battery unit cooling element 30 may be integrated with the EV battery unit, partially or fully included within the EV battery unit or located outside the EV battery unit. The EV battery unit cooling element 30 may include one or more plates, one or more heatsinks, one or more pipes, and the like.
c. Fluid control unit 60.
d. High-power consuming cooling unit 40.
e. DPRC based cooling unit 50 that includes DPRC radiator 51. The radiator 51 may be located on top of the vehicle, over the hood, and the like. The DPRC radiator may include one or more tubes that pass through a bulk made of a DPRC material Examples of a DPRC radiator are provided in FIG. 9—see bulk 51-9, fluid input 51-1, fluid output 51-1 and one or more pipes 51-3. The lower example of FIG. 9 also include a distribution unit 51-4 and an aggregation unit 51-1.
f. Controller 59.
g. One or more sensors 58.

The controller 59 is configured to control, at least, the fluid control unit 60. The controller may include one or more processing circuits. A processing circuit may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. The controller may include a memory and/or may be in communication with a non-transitory memory that is configured to store instructions for controlling (at least, the fluid control unit.

For example—the instructions that once executed by the controller may cause the controller to: control a fluidly coupling a daytime passive radiative cooling (DPRC) based cooling unit to a battery unit cooling element that is in fluid communication with the battery unit; and control a cooling the battery unit cooling element by the DPRC based cooling unit.

The controller 59 may control the fluid control unit based on sensed information sensed by one or more sensors.

According to an embodiment, the sensed information includes at least one of (a) a temperature related to the battery unit (for example—a temperature of the battery unit or a temperature that provided an indication about the temperature of the battery unit), (b) a state of the vehicle, wherein the state of the vehicle is selected out of multiple states, the multiple states may include an idle state and a non-idle state, the state may be sensed in various manners—for example by a vehicle computer, by a gas sensor, by a power consumption sensor, by an accelerometer, by a speed sensor, and the like (c) a fullness level of the battery unit, (d) ambient temperatures, or (e) a temperature related to the DPRC based cooling unit.

According to an embodiment, the fluid control unit 60 is configured to fluidly couple the DPRC based cooling unit 50 or to the high-power consuming cooling unit 40 for cooling the EV battery unit 20.

According to an embodiment, the controller 59 sends commands to the fluid control unit 60 that determine which entity is fluidly coupled to the EV battery unit 20. The determining of the controller may be impacted by information sensed by the one or more sensors 58.

According to an embodiment, the controller 59 is configured to detect that (a) the EV is idle for a prolonged time—or is expected to be idle for a prolonged time (for example more than 1-15 minutes)—and that (b) there is a need to cool the EV battery unit 20, and instructs the fluid control unit 60 to fluidly couple the DPRC based cooling unit 50 to the EV battery unit 20.

According to an embodiment, the controller 59 is configured to detect that (a) the EV starts a driving session—or is expected to start a driving session and that (b) there is a need to cool the EV battery unit 20—and instructs the fluid control unit 60 to fluidly couple the high-power consuming EV battery unit cooling unit 40 to the EV battery unit 20.

The fluid control unit 60 may include one or more fluid control units such as valves, pumps and the like.

According to an embodiment the fluid control unit 60 is configured to control the flow of fluid between the DPRC based cooling unit 50 and the EV battery unit cooling element 30.

According to an embodiment the fluid control unit 60 is configured to control the flow of fluid between the high power consuming cooling unit 40 and the EV battery unit cooling element 30.

According to an embodiment, the fluid control unit 60 includes one or more pumps.

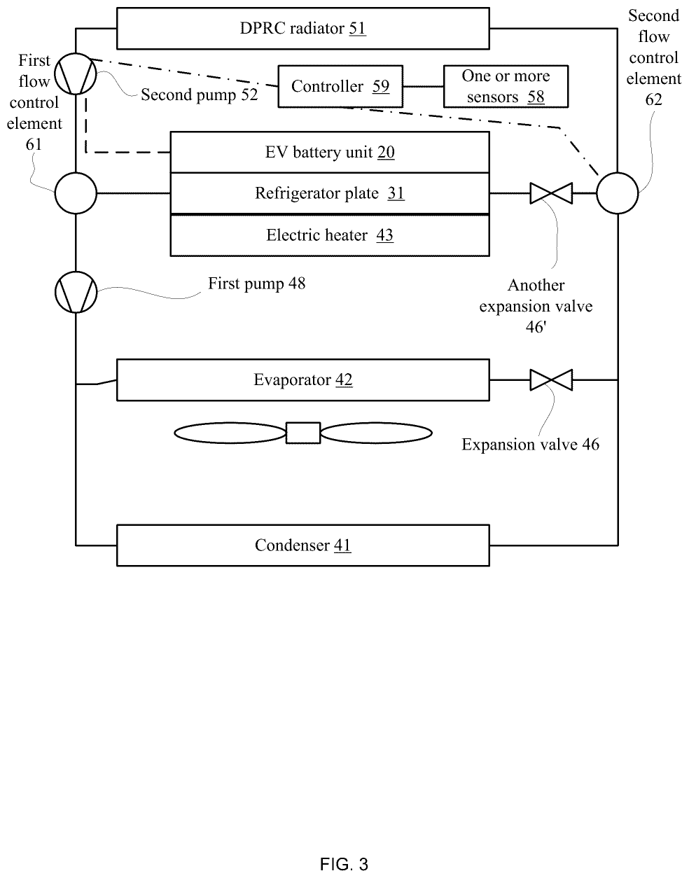

According to an embodiment the fluid control unit 60 includes a DPRC related pump that is configured to circulate a fluid between the DPRC based cooling unit and the battery unit cooling element. See, for example, second pump 52 of FIGS. 3, 4, 6 and 8.

According to an embodiment the fluid control unit 60 includes a high power consuming cooling unit pump that is configured to circulate a fluid between the high power consuming cooling unit and the battery unit cooling element. See, for example, first pump 48 of FIGS. 3, 4, 6 and 8.

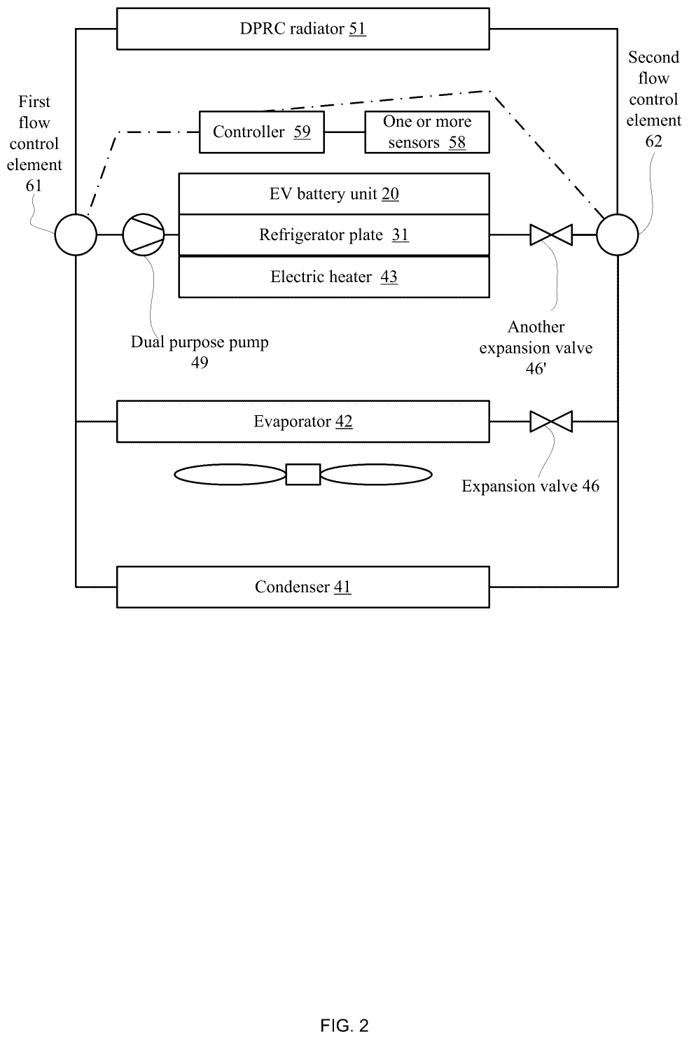

According to an embodiment the fluid control unit 60 includes a pump that is used for (a) circulating a fluid between the DPRC based cooling unit and the battery unit cooling element, and for (b) circulate a fluid between the high power consuming cooling unit and the battery unit cooling element. See, for example, dual purpose pump 49 of FIGS. 2, 5 and 7.

The circulation include providing a cooling fluid to the battery unit cooling element and receiving a warmer fluid from the battery unit cooling element and/or from a electric heater 43.

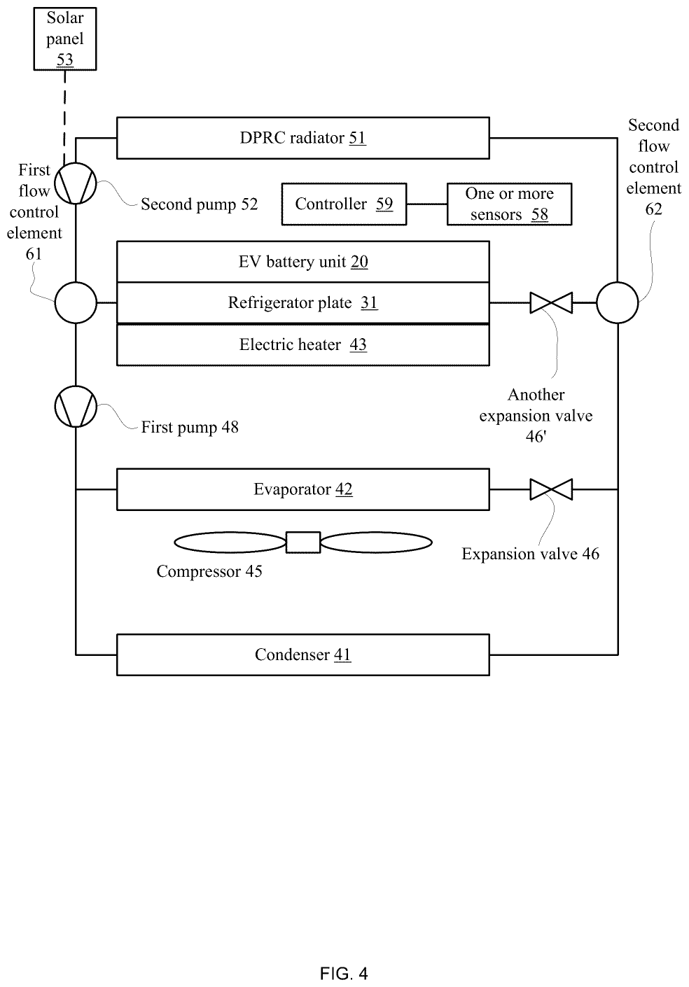

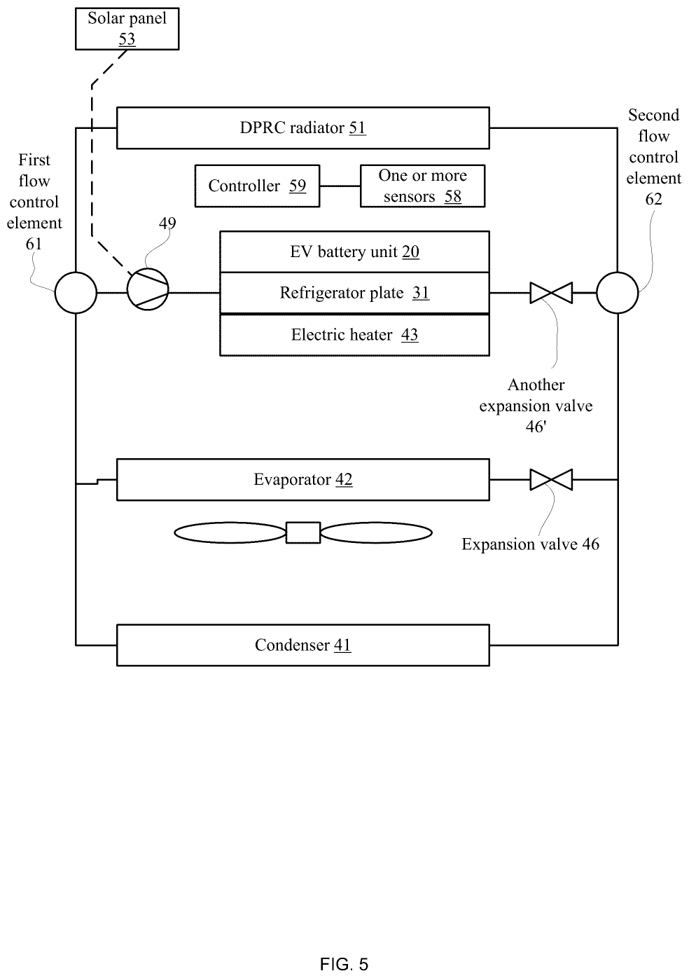

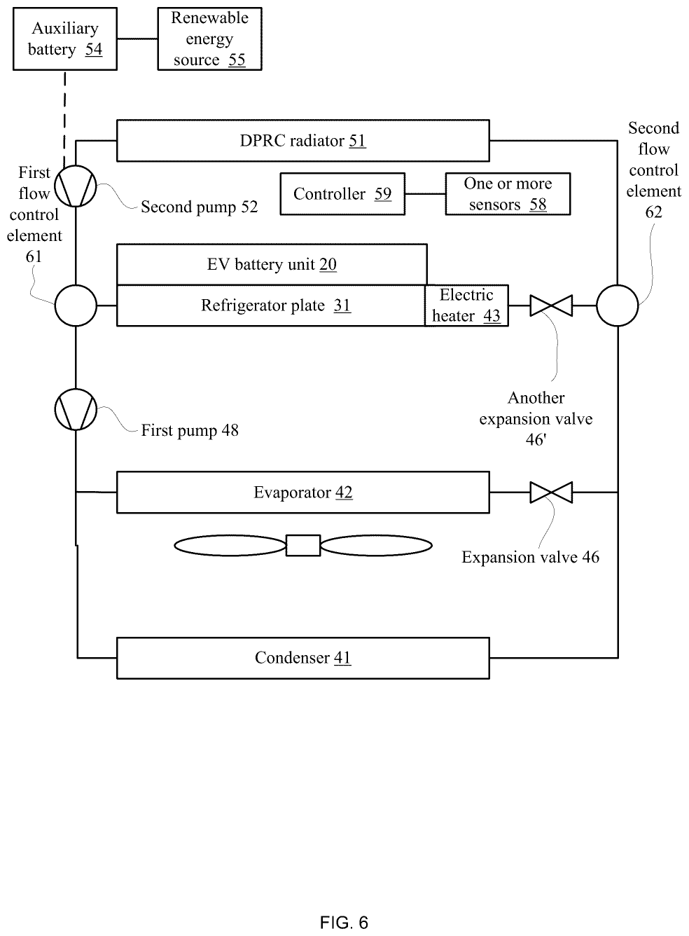

Any of the pumps of the fluid control unit may be powered by the EV battery unit and/or by another power source—such as a DPRC related energy source. In FIGS. 4 and 5 the DPRC related energy source is a solar panel 53. In FIG. 6 the DPRC related energy source is a renewable power source 55 and an auxiliary battery 44 that is charged by the renewable power source 55. It should be noted that the DPRC related energy source may also power other elements of the system such as the controller 59, one or more sensors 58, one or more fluid control elements, and the like.

FIG. 2 is an example of an EV 10 that includes:
a. EV battery unit 20.
b. EV battery unit cooling element such as refrigerator plate 31.
c. Fluid control unit 60 that includes first fluid control element 61, dual purpose pump 49, and second first fluid control element 62. The first and second fluid control units 61 are configured to fluidly couple the refrigerator plate to the high-power consuming cooling unit or to the DPRC based cooling unit.
d. A high-power consuming cooling unit that includes condenser 41, evaporator 42, expansion valve 46, electric heater 43 and another expansion valve 46′.
e. A DPRC based cooling unit that includes DPRC radiator 51.
f. Controller 59.
g. One or more sensors 58.

FIG. 3 is an example of an EV 10 that includes:
a. EV battery unit 20.
b. EV battery unit cooling element such as refrigerator plate 31.
c. Fluid control unit 60 that includes first fluid control element 61, first pump 48, second pump 52, and second first fluid control element 62. The first and second fluid control units 61 are configured to fluidly couple the refrigerator plate to the high-power consuming cooling unit or to the DPRC based cooling unit. In FIG. 3 the second pump 52 (as well as other components) is powered by the EV battery unit 20.
d. A high-power consuming cooling unit that includes condenser 41, evaporator 42, expansion valve 46, electric heater 43 and another expansion valve 46′.
e. A DPRC based cooling unit that includes DPRC radiator 51.
f. Controller 59.
g. One or more sensors 58.

FIG. 4 is an example of an EV 10 that includes:
a. EV battery unit 20.
b. EV battery unit cooling element such as refrigerator plate 31.
c. Fluid control unit 60 that includes first fluid control element 61, first pump 48, second pump 52, and second first fluid control element 62. The first and second fluid control units 61 are configured to fluidly couple the refrigerator plate to the high-power consuming cooling unit or to the DPRC based cooling unit. In FIG. 3 the second pump 52 (as well as other components) is powered by solar panel 53.
d. A high-power consuming cooling unit that includes condenser 41, evaporator 42, expansion valve 46, electric heater 43 and another expansion valve 46′.
e. A DPRC based cooling unit that includes DPRC radiator 51.
f. Controller 59.
g. One or more sensors 58.

FIG. 5 is an example of an EV 10 that includes:
a. EV battery unit 20.
b. EV battery unit cooling element such as refrigerator plate 31.
c. Fluid control unit 60 that includes first fluid control element 61, dual purpose pump 49, and second first fluid control element 62. The first and second fluid control units 61 are configured to fluidly couple the refrigerator plate to the high-power consuming cooling unit or to the DPRC based cooling unit. In FIG. 5 the dual purpose pump 49 (as well as other components) is powered by solar panel 53.
d. A high-power consuming cooling unit that includes condenser 41, evaporator 42, expansion valve 46, electric heater 43 and another expansion valve 46′.
e. A DPRC based cooling unit that includes DPRC radiator 51.
f. Controller 59.
g. One or more sensors 58.

FIG. 6 is an example of an EV 10 that includes:
a. EV battery unit 20.
b. EV battery unit cooling element such as refrigerator plate 31.
c. Fluid control unit 60 that includes first fluid control element 61, first pump 48, second pump 52, and second first fluid control element 62. The first and second fluid control units 61 are configured to fluidly couple the refrigerator plate to the high-power consuming cooling unit or to the DPRC based cooling unit. In FIG. 6 the second pump 52 (as well as other components) is powered by an auxiliary battery 54 that is charged by a renewable energy source 55.
d. A high-power consuming cooling unit that includes condenser 41, evaporator 42, expansion valve 46, electric heater 43 and another expansion valve 46′.
e. A DPRC based cooling unit that includes DPRC radiator 51.
f. Controller 59.
g. One or more sensors 58.

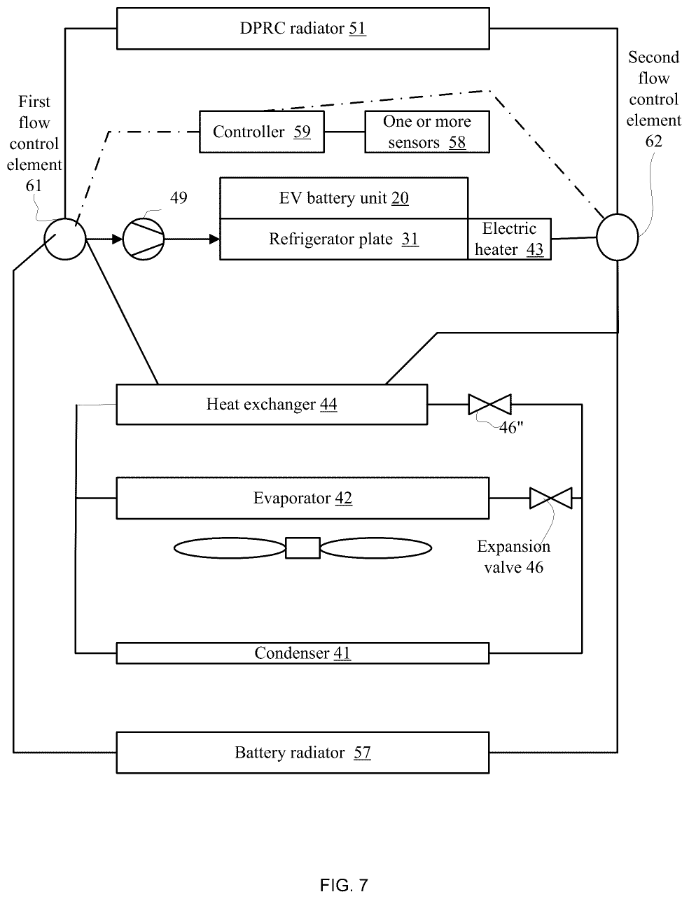

FIG. 7 is an example of an EV 10 that includes:
a. EV battery unit 20.
b. EV battery unit cooling element such as refrigerator plate 31.
c. Fluid control unit 60 that includes first fluid control element 61, dual purpose pump 49, and second first fluid control element 62. The first and second fluid control units 61 are configured to fluidly couple the refrigerator plate to the high-power consuming cooling unit or to the DPRC based cooling unit.
d. A high-power consuming cooling unit that includes condenser 41, evaporator 42, heat exchanger 44, battery radiator 57, expansion valve 46, electric heater 43, and another expansion valve 46′.
e. A DPRC based cooling unit that includes DPRC radiator 51.
f. Controller 59.
g. One or more sensors 58.

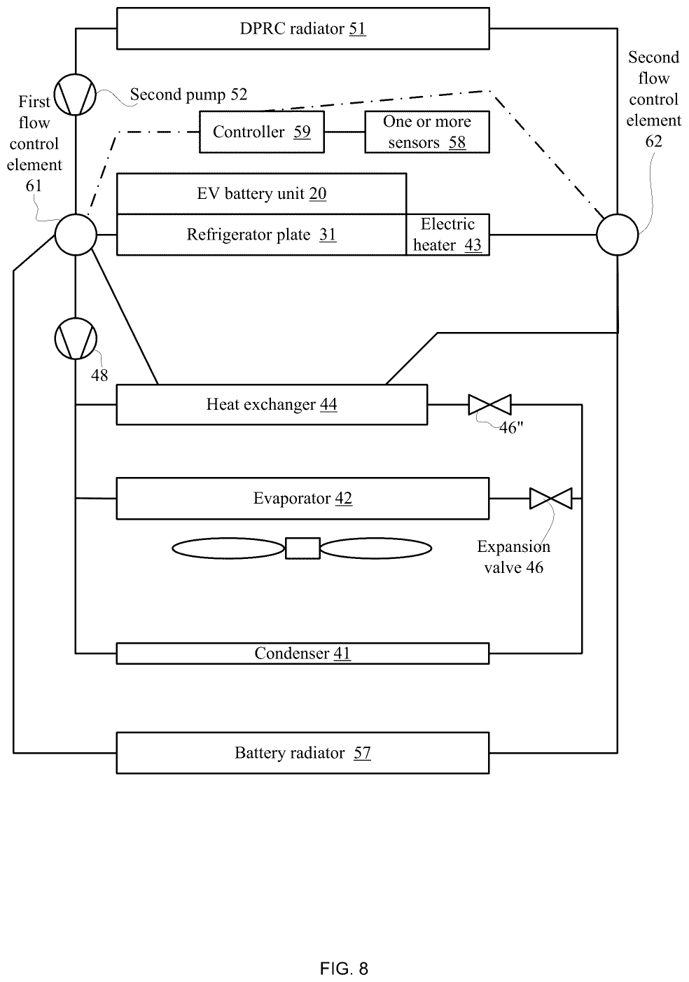

FIG. 8 is an example of an EV 10 that includes:
a. EV battery unit 20.
b. EV battery unit cooling element such as refrigerator plate 31.
c. Fluid control unit 60 that includes first fluid control element 61, first pump 48, second pump 52, and second first fluid control element 62. The first and second fluid control units 61 are configured to fluidly couple the refrigerator plate to the high-power consuming cooling unit or to the DPRC based cooling unit. In FIG. 6 the second pump 52 (as well as other components) is powered by an auxiliary battery 54 that is charged by a renewable energy source 55.
d. A high-power consuming cooling unit that includes condenser 41, evaporator 42, heat exchanger 44, battery radiator 57, expansion valve 46, electric heater 43, and another expansion valve 46′.
e. A DPRC based cooling unit that includes DPRC radiator 51.
f. Controller 59.
g. One or more sensors 58.

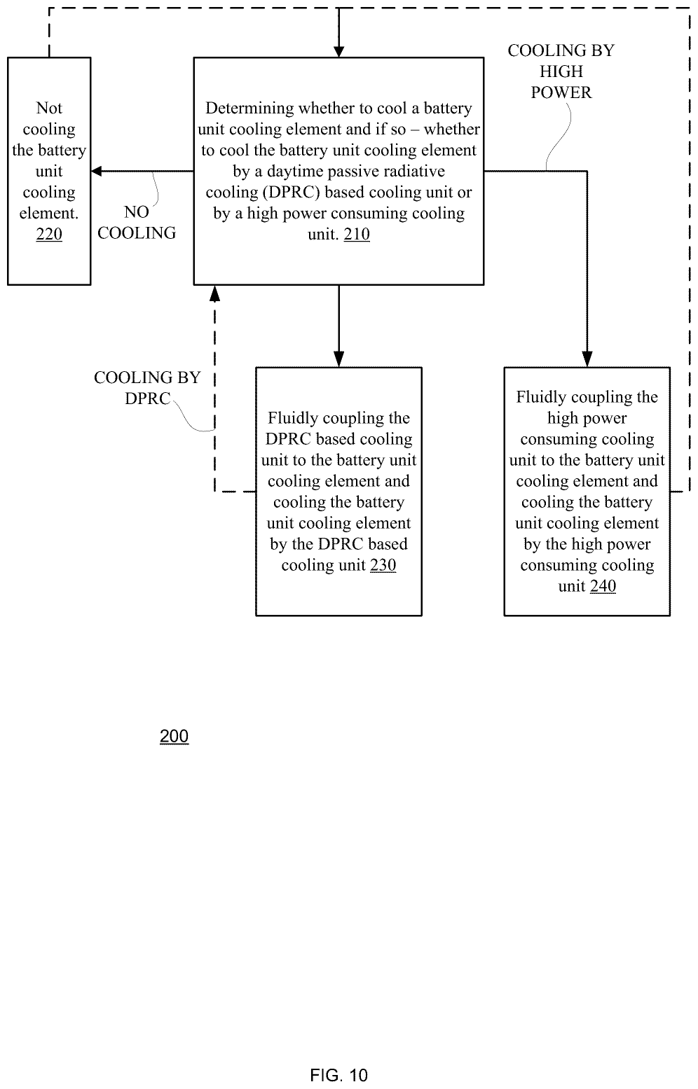

FIG. 10 illustrates an example of method 200 for cooling a battery unit of an electric vehicle.

According to an embodiment, method 200 starts by step 210 of determining whether to cool a battery unit cooling element and if so—whether to cool the battery unit cooling element by a daytime passive radiative cooling (DPRC) based cooling unit or by a high power consuming cooling unit.

When it is determined not to cool the battery unit cooling element—step 210 is followed by step 220 of not cooling the battery unit cooling element. Step 220 may be followed by step 210.

When it is determined to cool the battery unit cooling element by the DPRC based cooling unit—step 210 is followed by step 230 of fluidly coupling the DPRC based cooling unit to the battery unit cooling element and cooling the battery unit cooling element by the DPRC based cooling unit. Step 230 may be followed by step 210.

When it is determined to cool the battery unit cooling element by the high power consuming cooling unit—step 210 is followed by step 240 of fluidly coupling the high power consuming cooling unit to the battery unit cooling element and cooling the battery unit cooling element by the high power consuming cooling unit. Step 240 may be followed by step 210.

According to an embodiment, step 230 includes at least one of:
a. Circulating, by a DPRC related pump, a cooling fluid between the DPRC based cooling unit and the battery unit cooling element.
b. Powering the DPRC related pump by a DPRC related energy source.

According to an embodiment, step 210 is executed by a controller and is based on sensed information from one or more sensors.

According to an embodiment, the sensed information includes at least one of (a) a temperature related to the battery unit (for example—a temperature of the battery unit or a temperature that provided an indication about the temperature of the battery unit), (b) a state of the vehicle, wherein the state of the vehicle is selected out of multiple states, the multiple states may include an idle state and a non-idle state, the state may be sensed in various manners—for example by a vehicle computer, by a gas sensor, by a power consumption sensor, by an accelerometer, by a speed sensor, and the like (c) a fullness level of the battery unit, (d) ambient temperatures, or (e) a temperature related to the DPRC based cooling unit.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first”, “second”, “third” and “fourth” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for cooling a battery unit of an electric vehicle, the method comprising:
fluidly coupling a daytime passive radiative cooling (DPRC) based cooling unit to a battery unit cooling element that is in fluid communication with the battery unit; and
cooling the battery unit cooling element by the DPRC based cooling unit.

2. The method according to claim 1, wherein the cooling comprises circulating, by a DPRC related pump, a cooling fluid between the DPRC based cooling unit and the battery unit cooling element.

3. The method according to claim 2, comprising powering the DPRC related pump by a DPRC related energy source.

4. The method according to claim 3, where the DPRC related energy source is a renewable energy source.

5. The method according to claim 2, comprising stopping the fluidly coupling during a driving session of the electric vehicle, wherein a power consumption of the DPRC related pump is less than 20% from a power consumption of a driving session pump used for cooling the battery unit during the driving session.

6. The method according to claim 1, wherein the DPRC based cooling unit comprises a DPRC radiator that is positioned on top of the vehicle.

7. The method according to claim 1, comprising determining to perform the fluidly coupling based on sensed information sensed by one or more sensors.

8. The method according to claim 7, wherein the sensed information comprises a temperature related to the battery unit.

9. The method according to claim 7, wherein the sensed information comprises a state of the vehicle, wherein the state of the vehicle is selected out of multiple states, the multiple states comprise an idle state and a non-idle state.

10. The method according to claim 7, wherein the sensed information comprises a temperature related to the DPRC based cooling unit.

11. A system for cooling a battery unit of an electric vehicle, the system comprising:
a daytime passive radiative cooling (DPRC) based cooling unit;
a fluid control unit that is configured to selectively fluidly couple the DPRC based cooling unit to a battery unit cooling element that is in fluid communication with the battery unit; and
wherein the DPRC based cooling unit is configured to cool the battery unit cooling element while being fluidly coupled to the battery unit cooling element.

12. The system according to claim 11, comprising a DPRC related pump that is configured to circulate a cooling fluid between the DPRC based cooling unit and the battery unit cooling element.

13. The system according to claim 12, comprising a DPRC related energy source that is configured to power the DPRC related pump.

14. The system according to claim 13, where the DPRC related energy source is a renewable energy source.

15. The system according to claim 12, wherein the fluid control unit is configured to stop the fluidly coupling during a driving session of the electric vehicle, wherein a power consumption of the DPRC related pump is less than 20% from a power consumption of a driving session pump used for cooling the battery unit during the driving session.

16. The system according to claim 11, wherein the DPRC based cooling unit comprises a DPRC radiator that is positioned on top of the vehicle.

17. The system according to claim 11, comprising a controller that is configured to determine to perform the fluidly coupling based on sensed information sensed by one or more sensors.

18. The system according to claim 17, wherein the sensed information comprises a temperature related to the battery unit.

19. The system according to claim 17, wherein the sensed information comprises a state of the vehicle, wherein the state of the vehicle is selected out of multiple states, the multiple states comprise an idle state and a non-idle state.

20. A non-transitory computer readable medium for cooling a battery unit of an electric vehicle, the non-transitory computer readable medium stores instructions that once executed by a controller that comprises one or more processing circuits causes the controller to:
control a fluidly coupling a daytime passive radiative cooling (DPRC) based cooling unit to a battery unit cooling element that is in fluid communication with the battery unit; and
control a cooling the battery unit cooling element by the DPRC based cooling unit.
